(19) United States
(12) Patent Application Publication
(10) Pub. No.: US 2023/0418089 A1
(43) Pub. Date: Dec. 28, 2023

(54) DISPLAY APPARATUS

(71) Applicant: SONY GROUP CORPORATION, TOKYO (JP)

(72) Inventor: RYO KASEGAWA, TOKYO (JP)

(21) Appl. No.: 18/253,686

(22) PCT Filed: Oct. 26, 2021
(86) PCT No.: PCT/JP2021/039473

§ 371 Date: May 19, 2023

(30) Foreign Application Priority Data
Nov. 27, 2020 (JP) 2020-197317

(51) Int. Cl. G02B 30/56; G02B 5/32

(52) U.S. Cl. CPC G02B 30/56; G02B 5/32

(57) ABSTRACT

To provide a realistic viewing experience by displaying a virtual image in a state of being superimposed on a background. To achieve the object described above, a display device according to an embodiment of the present technology includes a display unit group. The display unit group includes at least two or more sets of display units disposed in a circumferential direction. Each set of the display units includes a screen onto which an object image is projected from a projection apparatus, and a reflective holographic lens that diffracts the object image and delivers the object image to a pupil of an observer. This makes it possible to provide a realistic viewing experience.

### TECHNICAL FIELD

The present technology relates to a display apparatus applicable to a hologram or the like.

### BACKGROUND ART

Conventionally, as a method of superimposing a background and a video on each other, there is a technique using Pepper's ghost, in which a video on a display is returned to an observer by using a half mirror and then superimposed on a landscape. With the display and the half mirror being used as a set, a plurality of sets is disposed in azimuth directions to perform display in a manner that an observation is performed from the outside direction of the circumference toward the display apparatus located on the inside, thus allowing an observation from multiple directions. However, due to the tradeoff between the half mirror and a display luminance of the video, it is difficult to maintain the display luminance while maintaining a high background luminance. Further, there is a problem that a width of a virtual image is limited by a width of the half mirror.

Other than the technique of Pepper's ghost, there is a technique of using a half mirror and a recursive reflective material to display a real image at a position between the half mirror and the pupil of an observer. When a plurality of half mirrors is prepared and disposed such that a radius inscribed on each half mirror has the same distances between the half mirror and the reflective material and between the half mirror and the screen, a real image is displayed on the center of the inscribed circle, and a viewing angle range of the real image in the azimuth direction of the pupil can be widened as compared to the case where a single half mirror is used. However, a real image obtained using a reflective surface close to a vertex has to be displayed to be small, and if it is intended to be displayed to be long in the circumferential axis direction, a width of a virtual image is limited by a width of the mirror on the vertex side. Further, since a background transmittance and a real image luminance due to the recursive reflection and the reflectance of the half mirror are traded off, it is difficult to ensure the display luminance while maintaining a high background luminance.

Further, in general, there is a method in which a real image is superimposed on a peripheral landscape by using a reflective holographic lens to perform background superimposition display, and the real image is made to float between a hologram surface and a pupil. In this case, there is a problem that the range in which a light beam connecting an object image surface of the hologram lens and the real image reaches the pupil is narrow and limited, and thus a viewable range is narrow with respect to a viewpoint movement toward the azimuth direction.

Patent Literature 1 discloses an optical system that is rotation symmetrical around a rotation symmetrical axis, the optical system including, in a cross-section including the rotation symmetrical axis, an image forming means using a refractive surface or reflective surface having a discontinuous shape or an image forming means using diffraction, and in a cross-section orthogonal to the rotation symmetrical axis, an image forming means using a front surface of a continuous rotation body. This provides an optical system that captures or projects an omnidirectional image at high resolution, has a small size, satisfactorily corrects aberrations, and has high resolution (paragraphs to of the specification, FIG. 1, and the like of Patent Literature 1).

### CITATION LIST

### Patent Literature

Patent Literature 1: Japanese Patent Application Laid-open No. 2008-39972

### DISCLOSURE OF INVENTION

### Technical Problem

As described above, there is a demand for a technology capable of providing a realistic viewing experience by displaying a virtual image in a state of being superimposed on a background.

In view of the circumstances as described above, it is an object of the present technology to provide a display apparatus capable of providing a realistic viewing experience.

### Solution to Problem

In order to achieve the above object, a display apparatus according to an embodiment of the present technology includes a display unit group.

The display unit group includes at least two or more sets of display units disposed in a circumferential direction.

Each set of the display units includes a screen onto which an object image is projected from a projection apparatus, and a reflective holographic lens that diffracts the object image and delivers the object image to a pupil of an observer.

Such a display apparatus includes a display unit group including at least two or more sets of display units disposed in a circumferential direction. The display unit includes a screen onto which an object image is projected from a projection apparatus, and a reflective holographic lens that diffracts the object image and delivers the object image to a pupil of an observer. This makes it possible to provide a realistic viewing experience.

### BRIEF DESCRIPTION OF DRAWINGS

FIG. 1 is a diagram schematically showing a basic configuration of a display unit.

FIG. 2 is a schematic diagram showing a specific optical example in a regular reflection glare.

FIG. 3 is a graph showing reflectance and transmittance of Fresnel reflections of light incident on an interface.

FIG. 4 is a schematic diagram schematically showing a display unit group.

FIG. 5 is a diagram showing light beams when a real image surface is displayed.

FIG. 6 is a schematic view showing an example of the display apparatus.

FIG. 7 is a schematic diagram showing an arrangement example of reflective holographic lenses in the display apparatus.

FIG. 8 is a schematic view showing another example of the display apparatus.

FIG. 9 is a schematic view showing another example of the display apparatus.

FIG. 10 is a diagram showing a two-light flux exposure optical system for exposure of a reflective holographic lens.

### MODE(S) FOR CARRYING OUT THE INVENTION

Hereinafter, embodiments according to the present technology will be described with reference to the drawings.

### First Embodiment

[Basic Configuration of Display Unit]

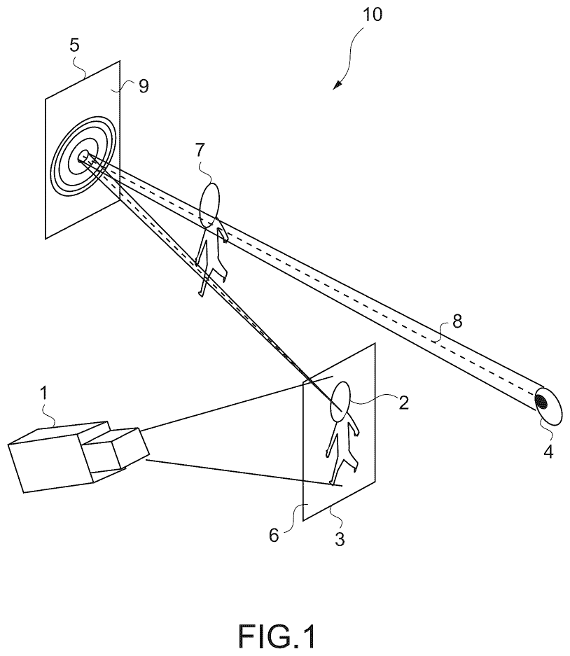

FIG. 1 is a diagram schematically showing a basic configuration of a display unit according to a first embodiment of the present technology. As shown in FIG. 1, a display unit 10 includes a screen 3, onto which an object image 2 is projected from a projector 1, and a reflective holographic lens 5 that diffracts the object image 2 to deliver the object image 2 to a pupil 4 of an observer. In this embodiment, the screen 3 and the reflective holographic lens 5 are used as a set to constitute the display unit 10.

The screen 3 includes a planar object image surface 6 and forms an object image 2. In this case, the object image 2 is an image as a target image to be displayed and is typically a video. The object image surface 6 is a surface that diffuses and emits projected light. In this embodiment, a position of the screen 3 is determined so as not to block real image light as viewed from a position of an assumed pupil 4, on the basis of a real image 7, an off-axis angle of an optical axis 8 of the real image 7, an upper end of the screen 3, a height of the object image, and the like. Note that the setting of the off-axis angle will be described later.

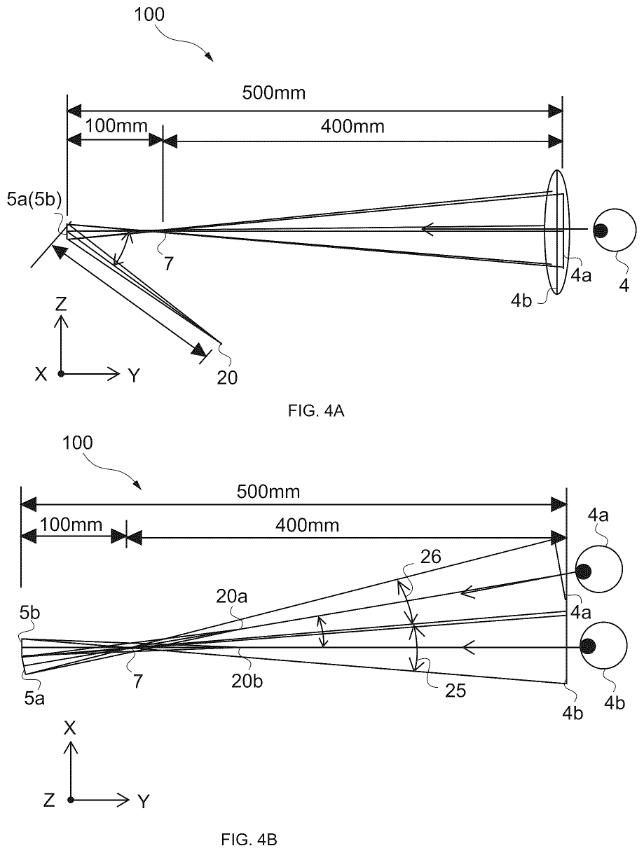

A diffusion angle of the screen 3 in the azimuth direction is favorably set such that an angle formed with an adjacent reflective holographic lens 5 (see FIG. 4) and the diffusion angle have the same half width at half maximum. Further, an elevation angle direction of the screen 3 is favorably set such that an angle formed by a line connecting the pupil and the image height of the real image and the diffusion angle have the same half width at half maximum. Further, it is better that the screen 3 has a high diffusion transmittance or diffusion reflectance. Furthermore, from the viewpoint of suppressing the transmission efficiency of diffused light and aberration of the image surface, it is desirable that a perpendicular line of a diffusion surface of the screen and the optical axis of the reflective holographic lens 5 on the object image side are matched with each other.

Image light for displaying the pixels of the target image, each of which corresponds to each point, is emitted from each point of the object image surface 6 so as to be diffused at a predetermined diffusion angle. In other words, the screen 3 diffuses and emits the image light of the object image 2. The direction in which the image light is emitted is directed to the reflective holographic lens 5. FIG. 1 schematically shows an example of an optical path of the image light emitted to a surface 9 from the object image surface 2 (screen 3) of the display unit 10.

A specific configuration of the screen 3 is not limited. For example, as shown in FIG. 1, a reflective or transmissive diffusion screen that diffuses light projected from a projection-type projection apparatus such as the projector 1 and displays an image is used as the screen 3. Further, for example, a self-luminous display such as a liquid crystal display, an organic EL display, or a plasma display may also be used as the screen 3. In this case, a display surface of each display is the object image surface 6. In addition, any screen 3 capable of forming an object image such as the target image may be used.

The reflective holographic lens 5 is a reflective holographic optical element (HOE). The HOE is an optical element using a hologram technique and performs control of a traveling direction of light (optical path control) by diffracting the light using interference fringes recorded in advance. A reflective HOE is capable of controlling a direction of diffraction and reflection in which light is diffracted and reflected.

The reflective holographic lens 5 is configured to diffract and reflect the light incident in a specific angular range and transmit the light in other angular ranges. For example, the light incident on the surface 9 in a specific angular range is emitted from the surface 9 at an emission angle corresponding to the incidence angle thereof. Further, the light incident at an incidence angle other than the specific angular range is transmitted through the reflective holographic lens 5 with little diffraction caused by the interference fringes.

In this embodiment, the reflective holographic lens 5 diffracts the object image light of the object image 2 incident on the surface 9, emits the object image light from the surface 9, and displays the real image 7 of the object image 2 so as to overlap with the background. In other words, the reflective holographic lens 5 is capable of displaying the real image 7 by superimposition on the background.

The method of constituting the reflective holographic lens 5 is not limited. For example, if color displaying or the like is performed, three types of reflective holographic lenses 5 respectively exposed with RGB light are stacked and used. Further, for example, a photopolymer or the like capable of multiple exposure may be used. In this case, the reflective holographic lens 5 includes interference fringes exposed with light having different wavelengths.

The projector 1 projects image light onto the screen 3. For example, in order to display a real image 7 at a high resolution of approximately 100 ppi, a relationship between the incidence angle and the diffraction angle on the optical axis of the reflective holographic lens 5 follows the following equation.

Sinθin+mλ/Λ=sinθout

In this case, θin represents an incidence angle, Λ represents a HOE boundary pitch, λ represents a dominant wavelength of a reproduction light source, and θout represents an emission diffraction angle. Further, sinθout-Sinθin represents an off-axis angle.

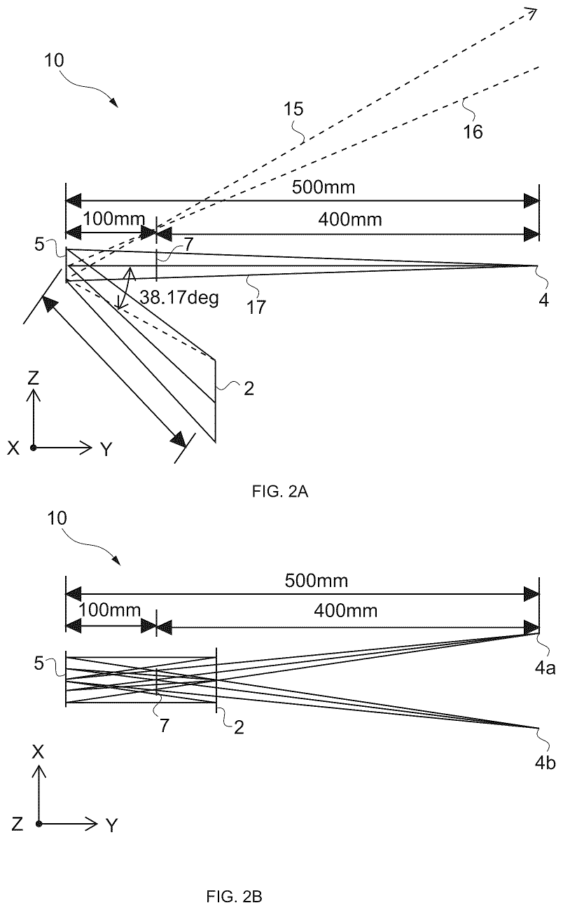

Since it is desirable that the image light from the object image surface 6 have a half width at half maximum in wavelength of approximately 2 nm from the above relationship of the diffraction angle, it is desirable to use a laser light source capable of providing RGB light in a narrow band. For example, in the case of FIG. 2, the projector 1 is a scanning laser projector, and a green wavelength of 524 nm is used. As a matter of course, the wavelength may be other than 524 nm, and a required half width at half maximum in wavelength may be different in accordance with the resolution required for the real image 7.

The angle of view of the projector 1 only needs to change in accordance with a focal length and cover the entire screen 3. The projector 1 may perform color display using a photopolymer that is sensitive to RGB at the same time. Further, it is favorable that the optical axis of the projection light of the projector 1 and the optical axis of the reflective holographic lens are matched with each other.

If the screen 3 is of a reflective type and is parallel to the surface 9 of the reflective holographic lens 5, it is favorable to align the optical axis of the projection light of the projector 1 with an optical axis inverted to be axially symmetric with respect to a perpendicular line provided at the point where the optical axis 8 of the reflective holographic lens 5 and the screen 3 intersect with each other. Further, if the screen 3 is of a reflective type and is disposed perpendicularly to the optical axis of the reflective holographic lens 5, it is desirable to project an image at the smallest angle with respect to the perpendicular line of the screen 3, which does not block the incident light beam onto the reflective holographic lens 5.

Here, a specific example of the optical elements of the display unit 10 shown in FIG. 1 will be described.

For example, description will be given on a case where a distance from the reflective holographic lens 5 to a position of the assumed pupil 4 is 500 mm, the height of the real image 7 is a ±10 mm angle, the elevation angle of the pupil 4 is 0 degrees, the azimuth angle of the pupil 4 is 0 degrees, and a distance from the reflective holographic lens 5 to the object image 2 is 200 mm, and the real image 7 is displayed at a position of 100 mm from the reflective holographic lens 5 in the direction of the pupil 4.

Here, it is assumed that the elevation angle is set in an off-axis angle direction of the reflective holographic lens 5, the direction of the object image 2 is negative, and the direction opposite to the object image 2 is positive. In other words, in this embodiment, the screen 3 is disposed at a position different from the reflective holographic lens 5 in the elevation angle direction (negative direction). Further, a direction orthogonal to the elevation angle direction is set as an azimuth angle, and an angle from the left side is defined as a negative angle and an angle from the right side is defined as a positive angle in consideration of the real image 7.

The reflective holographic lens 5 follows 1/a−1/b=1/f, which also applies to a magnifying concave mirror. Note that “a” is a distance from the reflective holographic lens 5 to the object image surface 2, “b” is a distance from the reflective holographic lens 5 to the real image 7, and “f” is a focal length. In this case, when the focal length is 100 mm, it is possible to provide a=200 mm and b=100 mm.

[Setting of Off-Axis Angle]

Here, description will be given on the setting of an off-axis angle of the optical axis 8 of the real image 7. In this embodiment, the off-axis angle is set in consideration of the following three points.

Assumed elevation angle of the pupil and a regular reflection glare in an elevation-angle moving range.

Light loss due to Fresnel reflections when the object image light is incident on the surface of the reflective holographic lens.

Non-blocking of the real image light by the screen 3.

In the regular reflection glare, the luminance of the regular reflection light from the substrate of the reflective holographic lens is lower than that of the diffraction light, but this causes a loss of the sense of reality of the real image light. Further, in the regular reflection glare, use of an anti-reflection (AR) coating of a moth-eye structure or the like can prevent the glare of the object image light to some extent. However, it is desirable for an observer to provide an off-axis angle such that the glare is difficult to visually recognize when expected from the angle (elevation angle) around the elevation angle of the assumed pupil of the observer.

FIG. 2 is a schematic diagram showing a specific optical example in the regular reflection glare.

As shown in FIG. 2, in the regular reflection glare, an angle (dotted line 15) connecting the upper end of the object image 2 and the lower end of the reflective holographic lens 5 to each other only needs to be lower than an upper limit angle (dotted line 16) in an assumed viewpoint elevation angle movement. Here, the assumed viewpoint elevation angle movement indicates a range in the elevation angle direction, in which the pupil 4 searches for the real image 7 to visually recognize the real image 7 when the observer intends to view the real image 7.

A of FIG. 2 is a schematic diagram viewed from a side surface of the display unit 10 (e.g., in the X-axis direction). B of FIG. 2 is a schematic diagram viewed from an upper surface of the display unit 10 (e.g., in the Z-axis direction).

FIG. 2 illustrates an example in which the position of the pupil 4 is set to an elevation angle of 0 degrees, and the upper limit of the assumed viewpoint elevation angle movement is set to +20 degrees, that is, a range of 20 degrees in a direction opposite to the object image 2 is ensured as a viewing region.

Further, in FIG. 2, a width and a height of the object image 2 are each set to 40 mm, an inclination angle of the object image 2 is set to 0 degrees with respect to the reflective holographic lens 5. Further, the reflective holographic lens 5 has a vertical length of 30 mm and a horizontal length of 70 mm.

Further, similarly to FIG. 1, in FIG. 2, a distance from the reflective holographic lens 5 to a position of the assumed pupil 4 is 500 mm, the height of the real image 7 is a ±10 mm angle, the elevation angle of the pupil 4 is 0 degrees, the azimuth angle of the pupil 4 is 0 degrees, a distance from the reflective holographic lens 5 to the object image 2 is 200 mm, and the real image 7 is displayed at a position of 100 mm from the reflective holographic lens 5 in the direction of the pupil 4.

As shown in A and B of FIG. 2, the object image light emitted from the object image 2 is incident on the reflective holographic lens 5. The incident object image light is emitted by the reflective holographic lens 5 to each of a right pupil 4a and a left pupil 4b, and the real image 7 is displayed.

From the above conditions, as shown in FIG. 2, a reflection light beam angle line 15 from the upper end of the object image light exceeds an upper limit angle line 16 of the assumed viewpoint elevation angle movement of the pupil 4. In other words, under the conditions shown in FIG. 2, the reflection light beam from the upper end of the object image light exceeds the upper limit of the assumed viewpoint elevation angle movement, and thus it is difficult for the observer to visually recognize the glare of the object image light.

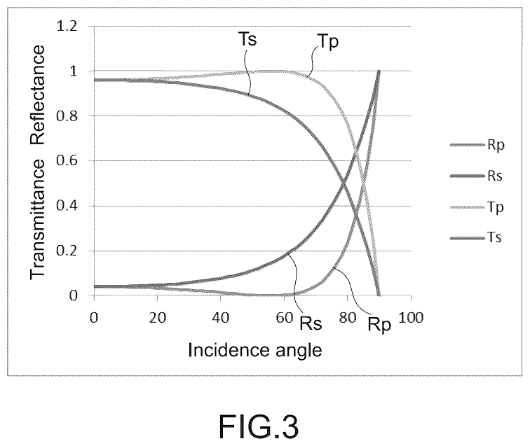

FIG. 3 is a graph showing reflectance and transmittance of Fresnel reflections of light incident on an interface. The vertical axis of the graph represents transmittance and reflectance, and the horizontal axis represents the incidence angle of the light with respect to the interface. FIG. 3 shows reflectance (Rs and Rp) of S-polarized light and P-polarized light, and transmittance (Ts and Tp) of S-polarized light and P-polarized light. For example, a part of the incident light incident on the interface is reflected at the interface, and another part thereof is transmitted through the interface and enters the inside. The reflectance and the transmittance at that time take values corresponding to the incidence angle of the incident light and the ratio of the S-polarized light and the P-polarized light included in the incident light.

In order to prevent the regular reflection light from being reflected on the pupil 4, it is desirable to cause the object image light to be incident with an angle with respect to the surface 9 as much as possible (increase the incidence angle). On the other hand, as shown in the graph of FIG. 3, the reflectance of Fresnel reflections increases as the incidence angle increases. Thus, it is conceivable that, when the incidence angle increases, the amount of light incident on the surface 9 decreases and the brightness of the real image 7 decreases.

In other words, regarding the setting of the off-axis angle, an element that determines the off-axis angle is also the degree to which light loss due to Fresnel reflections is allowed when the object image light is incident on the surface of the reflective holographic lens.

Here, a reflective holographic lens substrate is a glass substrate to which a photopolymer film, on which a hologram lens is recorded, is attached. Further, assuming that the photopolymer surface is a light incident surface and that a refractive index n is 1.53, Fresnel reflection loss occurs at the interface when the light is incident.

As shown in FIG. 3, since Fresnel reflections increase according to the incidence angle, the incidence angle at the center of the angle of view is determined depending on the degree to which the decrease in the light source intensity due to the Fresnel reflections is allowed and the degree to which the angle seen by the movement of the pupil 4 is expected.

Here, the incidence angle at the center of the angle of view refers to the center angle (projection angle) of the radiation angle of the object image light projected from the projector 1. For example, the incidence angle at the center of the angle of view is set such that the regular reflection light is reflected in a direction deviating from the upper limit of the assumed viewpoint elevation angle movement of the pupil 4, and the reflectance of Fresnel reflections becomes low within a possible range.

For example, when the limit value of the amount of decrease in the light source intensity due to Fresnel reflections is set to 30%, as shown in FIG. 3, the maximum incidence angle is set to approximately 70 degrees. In the configuration of FIG. 2, the angle between an incident light beam from the object light to the reflective holographic lens 5 and a reflection light beam to the pupil 4 is 38.17 degrees, which sufficiently exceeds the maximum incidence angle.

Also in regard to the fact that the screen 3 does not block the real image light, it is necessary to perform setting in consideration on whether or not a diffracted light beam 17 from the reflective holographic lens 5 corresponding to the lower end of the real image 7 among the light beams connecting the real image 7 with the pupil 4 is arranged so as not to be concealed by the screen 3. In the configuration of FIG. 2, the diffracted light beam 17 from the reflective holographic lens 5 corresponding to the lower end of the real image 7 is at a position of 82 mm to the upper end of the screen 3, and the screen 3 does not conceal the real image 7.

Note that the upper limit of the assumed viewpoint elevation angle movement, the limit value of the amount of decrease in the light source intensity, and the position of the screen 3 are not limited to the example described above.

[Optical Configuration for Enlarging Azimuth Angle Field Of Real Image Display]

FIG. 4 is a schematic diagram schematically showing a display unit group. A of FIG. 4 is a schematic diagram of a display unit group 100 as viewed from a side surface (for example, the X-axis direction). Further, B of FIG. 4 is a schematic diagram of the display unit group 100 as viewed from an upper surface (for example, the Z-axis direction).

In FIG. 4, description will be given on the principle of expanding a viewing angle of an observer by providing multiple display units 10 shown in FIG. 1.

For example, FIG. 4 shows two sets of display units 10, that is, two reflective holographic lenses 5 (5a and 5b). The photopolymer attached to the substrate of the reflective holographic lens 5 having a 20 mm width in the lateral direction is exposed such that the lens diameter of the reflective holographic lens 5 is 20 mm, a distance from the reflective holographic lens 5 to an object image point 20 is 200 mm, and a distance from the reflective holographic lens 5 to the real image 7 is 100 mm. Further, the angle formed by the two reflective holographic lenses 5 is 10 degrees, and the two reflective holographic lenses 5 are disposed to be continuous in the azimuth direction.

Further, in FIG. 4, a distance from the reflective holographic lenses 5a and 5b to the position of the assumed pupil 4 (surfaces a and 4b of pupil 4) is set to 500 mm, and the height of the real image 7 is a ±10 mm angle.

Further, the elevation angle of the pupil 4a with respect to the reflective holographic lens 5a is 0 degrees, and the azimuth angle of the pupil 4a is 0 degrees. Further, the elevation angle of the pupil 4b with respect to the reflective holographic lens 5b is 0 degrees, and the azimuth angle of the pupil 4b is 0 degrees. The distance from the reflective holographic lens 5 to the object image 2 is 200 mm, and the real image 7 is displayed at the position of 100 mm from the reflective holographic lens 5 in the direction toward the pupil 4.

Here, the surface of the pupil 4 indicates a range, of the pupil 4 in the azimuth direction, in which the real image 7 can be visually recognized.

As shown in FIG. 4, the reflective holographic lens 5 is disposed perpendicularly to the elevation angle of the pupil 4. Further, the center axes of circles (not shown) inscribed on the surfaces of the respective reflective holographic lenses 5 are matched with each other, and the center axes of circles (not shown) inscribed on the surfaces including the object image points 20 (20a and 20b) also are matched with each other. In addition, the center axis of the circle inscribed on the surface of each reflective holographic lens 5 is matched s with the center axis of the circle inscribed on the surface including the object image point 20. In other words, the positions of the matched center axes correspond to the position of the real image 7.

In the reflective holographic lenses 5a and 5b each having a lens diameter of 20 mm, the real image 7 can be viewed from a viewing range 25 in a first azimuth direction and a viewing range 26 in a second azimuth direction. In this embodiment, the reflective holographic lenses 5a and 5b are disposed adjacently to each other, so that the viewing range 25 and the viewing range 26 are expanded. Further, light from the object image points 20a and 20b is displayed at the center of an inscribed circle having a diameter of 100 mm of the reflective holographic lens 5.

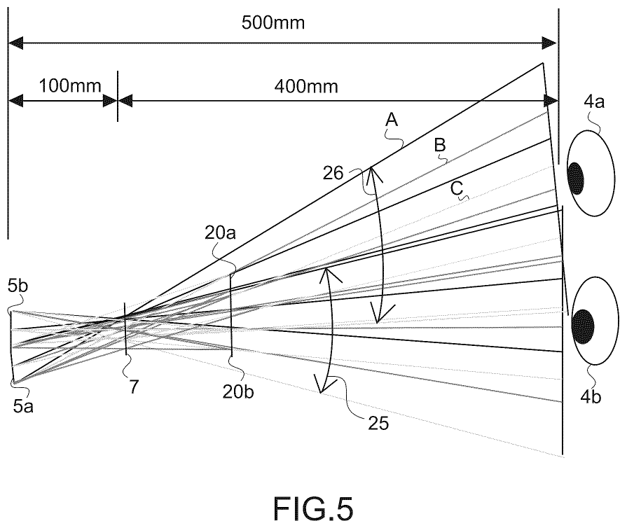

FIG. 5 is a diagram showing light beams when a real image surface is displayed.

FIG. 5 shows a positional relationship similar to that of FIG. 4. In this embodiment, the object image points 20 in FIG. 4 are assumed to be object image surfaces 20a and 20b, and their widths are set to be 20 mm. Further, the diameter of each reflective holographic lens 5 is set to 20 mm.

In FIG. 5, object image light beams A, B, and C are emitted from the object image surfaces 20 to the reflective holographic lenses 5a and 5b. For example, the incident object image light beams A, B, and C are RGB light beams. The light beams are diffracted by the reflective holographic lenses 5a and 5b and form a real image 7 having a height of a ±10 mm angle on the center axis of a circle (not shown) having a diameter of 200 mm, which is inscribed on each reflective holographic lens 5.

As shown in FIG. 5, the diffraction viewing ranges from both ends of the object image surfaces 20 are continuous. In this embodiment, the angle formed with the surface of an adjacent reflective holographic lens 5 is set to be equal to or less than the half width at half maximum of the diffraction efficiency in the azimuth direction at the assumed elevation angle of the pupil. Thus, the real image 7 is constantly displayed to be continuous from the pupil 4a to the pupil 4b in the azimuth direction around the axis.

The half width at half maximum of the diffusion angle in the azimuth direction of the screen 3 is set to be an angle equal to or less than a half-value angle of the diffraction efficiency of the HOE, so that the glare from the adjacent screen 3 is prevented.

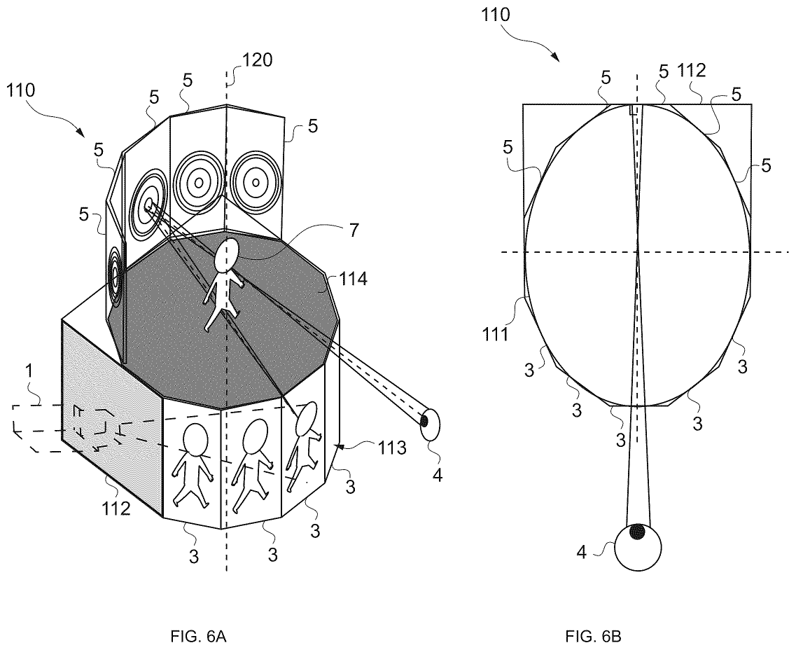

FIG. 6 is a schematic view showing an example of a display apparatus. A of FIG. 6 is a perspective view of a display apparatus 110. B of FIG. 6 is a top view of the display apparatus 110 as viewed from a direction of a dotted line 120.

As shown in A of FIG. 6, the display apparatus 110 includes the display unit group 100. In this embodiment, in the display unit group 100, five sets of display units each including the reflective holographic lens 5 and the screen 3 are disposed.

In this embodiment, the display unit groups 100 are disposed adjacently to each other in the circumferential direction. In other words, the surfaces of the reflective holographic lenses 5 and the screens 3 are disposed to have one inscribed circle 111. Further, the reflective holographic lens 5 of the display unit group 100 is not disposed at a position axially symmetric with respect to an axis 120 passing through the center of the inscribed circle 111.

As shown in A of FIG. 6, a real image 7 is displayed, at the position of the axis 120 passing through the center of the inscribed circle 111, from the object image light emitted from each reflective holographic lens 5.

Further, the display apparatus 110 includes a projector 1 that projects the object image 2 onto the screen 3, and a fixing base 112 as a transparent substrate that holds the screen 3. In this embodiment, as shown in FIG. 6, the fixing base 112 includes a lateral surface 113 that holds the screen 3, and a light-transmitting stage base 114 on which the real image 7 is displayed. In this embodiment, the fixing base 112 has a shape including the inscribed circle 111, which is inscribed on each surface of the reflective holographic lens 5 and each surface of the screen 3.

Note that FIG. 6 shows the reduced number of projectors 1. The number of projectors 1 may be the same as the number of screens 3, or the simultaneous projection may be performed on a plurality of screens 3. Further, the shape of the fixing base 112 is not limited.

As shown in FIG. 6, the display units are disposed on the circumference in the azimuth direction, so that the viewing angle in the azimuth direction can be expanded for display.

Further, by using the light-transmitting stage base 114, the relative positional relationship with the real image 7 is easy to be grasped, and the sense of reality is further increased.

Further, an eaves may be connected to the upper end of the reflective holographic lens 5 in order that the projection light of the projector 1 does not directly enter the eyes.

Further, if the screen 3 is a reflective diffusion screen, the back surface of the screen may be shielded such that the projected object image is not directly visible by the observer.

As described above, the display apparatus 110 according to this embodiment includes the display unit group 100 including at least two or more sets of the display units 10 disposed in the circumferential direction, each set of the display units 10 including the screen 3, on which the object image 2 is projected from the projector 1, and the reflective holographic lens 5 that diffracts the object image 2 and delivers the object image 2 to the pupil 4 of the observer. This allows a realistic viewing experience.

In the present technology, the surface of a reflective diffraction grating is disposed orthogonally to a surface including the circumferential axis in the circumferential direction. In particular, the surface is disposed in parallel to the circumferential axis and continuously in the circumferential direction, so that a prism is formed. Further, a diffraction efficiency peak is provided to a predetermined elevation angle, and the diffraction efficiency is continuously kept in the azimuth direction, so that the real image is displayed without disappearing in the pupil movement in the azimuth direction.

Further, use of a transmissive reflective holographic lens makes it possible to cause a real image to emerge in a space including a background, and at the same time, possible to touch the real image.

### Second Embodiment

A display apparatus of a second embodiment according to the present technology will be described. In the following description, description of the components and operations similar to those of the display unit 10 including the screen 3 and the reflective holographic lens 5 and the like described in the above embodiment will be omitted or simplified.

In the embodiment described above, the display units 10 disposed adjacently to each other have no gaps at the ends thereof. The present technology is not limited to this, and the ends of the adjacent display units 10 may be overlaid, or there may be gaps between the display units 10.

In the embodiment described above, the case where the reflective holographic lenses 5 are adjacent to each other has been described. The present technology is not limited to this, and the reflective holographic lenses 5 may be disposed apart from each other. For example, the surface of a regular polygon may be partly configured using a structural member or the like. Alternatively, a gap may be provided between the reflective holographic lenses.

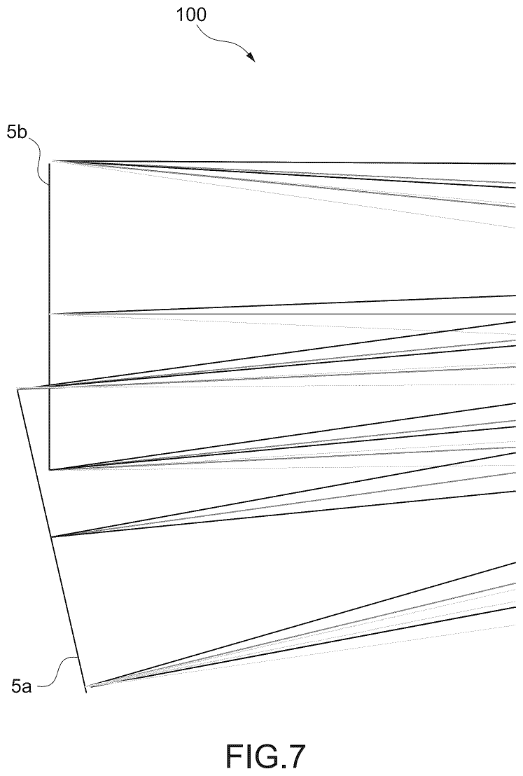

FIG. 7 is a schematic diagram showing an arrangement example of the reflective holographic lenses 5.

As shown in FIG. 7, the reflective holographic lenses 5 of the display unit group 100 in the display apparatus may be disposed with gaps therebetween, or may overlap with each other. In other words, if the arrangement can provide the inscribed circle 111 shown in FIG. 6, the arrangement of the display units 10 may be discretionarily provided. Even in such a case, it is possible to perform virtual image display with a sense of reality by appropriately setting the relative angle of each reflective hologram as described above.

### Third Embodiment

A display apparatus of a third embodiment according to the present technology will be described.

In the first embodiment, the off-axis angle is set to the positive side. In other words, it is assumed that the position of the pupil is in the direction opposite to the object image. The present technology is not limited to the above, and the off-axis angle may be set to the negative side.

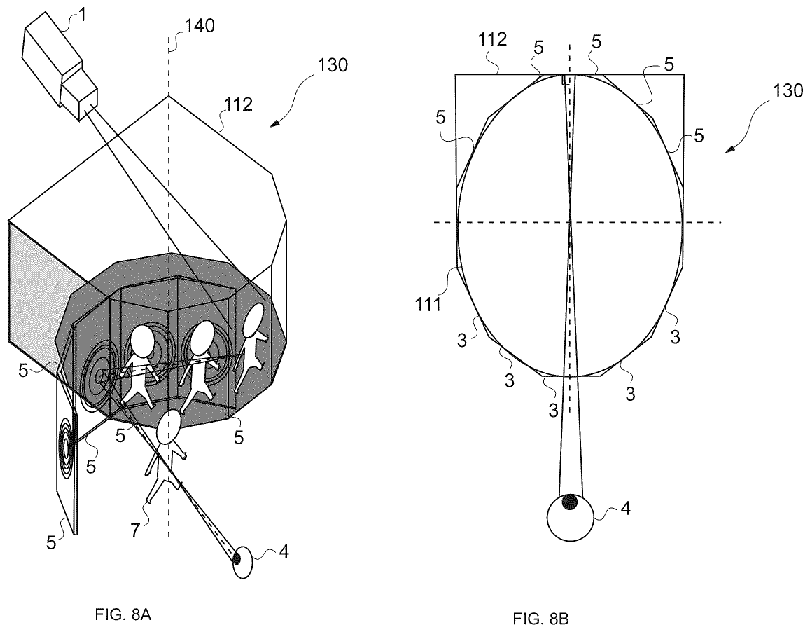

FIG. 8 is a schematic view showing another example of a display apparatus. A of FIG. 8 is a perspective view of a display apparatus 130. B of FIG. 8 is a top view of the display apparatus 130 as viewed from a direction of a dotted line 140.

In the display apparatus 130 shown in FIG. 8, as compared with the display apparatus 110 shown in FIG. 6, the reflective holographic lens 5 connected to the upper end of the fixing base 112 is connected in a vertically inverted manner. Further, the reflective holographic lens 5 may be exposed at an exposure angle from the negative side.

In other words, the arrangement of the projector 1 that projects the object image 2, the reflective holographic lens 5, the screen 3, and the like in the elevation angle direction in the display apparatus 130 can be discretionarily set in the positive direction and the negative direction.

### Fourth Embodiment

A display apparatus of a fourth embodiment according to the present technology will be described.

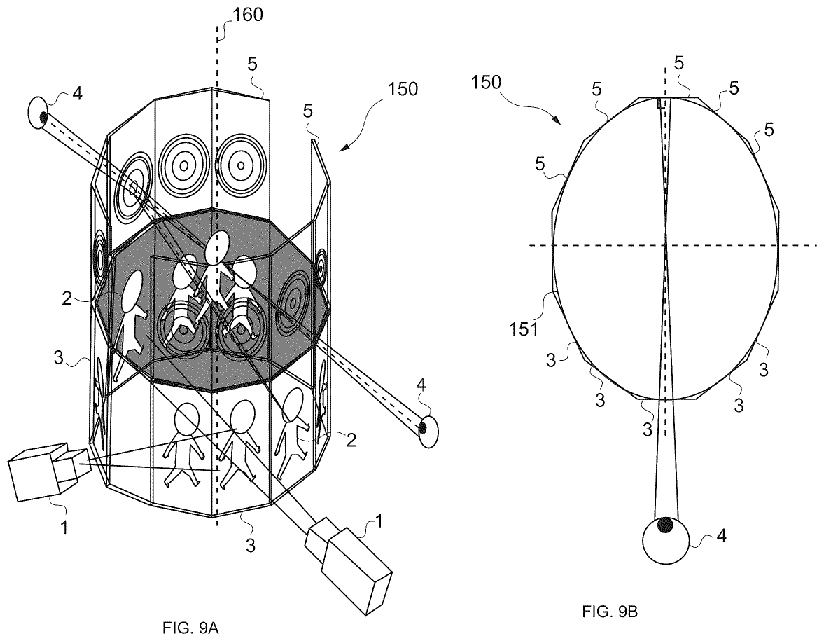

FIG. 9 is a schematic view showing another example of a display apparatus. A of FIG. 9 is a perspective view of a display apparatus 150. B of FIG. 9 is a top view of the display apparatus 150 as viewed from a direction of a dotted line 160.

In the display apparatus 150 shown in FIG. 9, the reflective holographic lenses 5 are disposed at positions axially symmetric with respect to an axis 160 passing through the center of an inscribed circle 151 inscribed on each surface of the reflective holographic lens 5.

For example, the display apparatus 150 includes a fixing base (not shown), the reflective holographic lenses 5 disposed at the upper end of the fixing base, screens 3 disposed at the lower end of the fixing base, and projectors 1 that project object images 2 onto the screens 3.

In this embodiment, the reflective holographic lenses 5 and the screens 3 are disposed on the circumference of the fixing base. In other words, the reflective holographic lenses 5 and the screens 3 are disposed such that the axis 160 passing through the center of the inscribed circle 151 inscribed on each surface of the reflective holographic lens 5 is matched with the axis 160 passing through the center of the inscribed circle 151 inscribed on each surface of the screen 3.

Further, a real image 7 is displayed on the axis 160 passing through the center of the inscribed circle 151 inscribed on each surface of the reflective holographic lens 5. In this embodiment, the real image 7 can be visually recognized through the reflective holographic lens 5.

In this embodiment, the projector 1 is disposed for the screen 3 corresponding to each reflective holographic lens 5. For example, the projector 1 may provide the object image surface by projecting the object image light. Further, any number of projectors 1 may be disposed. For example, the projectors in the number corresponding to the display units disposed to be axially symmetric may be disposed, or one projector capable of projecting an object image at 360 degrees may be disposed.

In addition to the above, the display apparatus 150 may have any configuration. For example, a roof may be provided to an upper portion of the space surrounded by the reflective holographic lenses 5. Further, the roof may be provided to protrude from the reflective holographic lenses 5 and to block excessive light coming from the projector 1 or to prevent the direct light coming from the projector 1 from directly entering the eyes when searching for a real image by the pupil movement.

### Other Embodiments

The present technology is not limited to the embodiments described above, and can achieve various other embodiments.

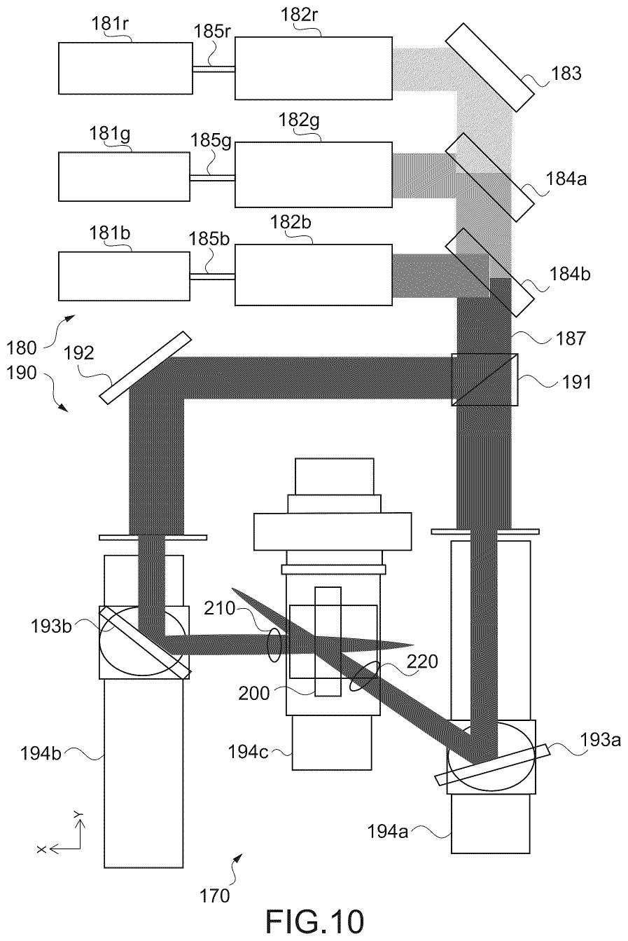

In the embodiments described above, the reflective holographic lens 5 is exposed. The exposure method is not limited and may be other than the method shown in FIG. 10.

FIG. 10 is a diagram showing a two-light flux exposure optical system for exposing the reflective holographic lens.

An exposure apparatus 170 shown in FIG. 10 is an apparatus for exposing the photopolymer of the reflective holographic lens 5 simultaneously with red, blue, and green light.

The exposure apparatus 170 includes a light source section 180 and an exposure section 190. The light source section 180 includes RGB laser light sources 181r, 181g, and 181b, beam expanders 182r, 182g, and 182b, a mirror 183, and half mirrors 184a and 184b.

The RGB laser light sources 211r, 211g, and 211b respectively emit red, green, and blue laser light beams 185r, 185g, and 185b. The beam expanders 182r, 182g, and 182b expand the laser light beams 185r, 185g, and 185b emitted from the respective laser light sources. The mirror 183 reflects the expanded red laser light beam 185r along a predetermined optical path. The half mirror 184a is disposed on a predetermined optical path and reflects the expanded green laser light beam 185g along the predetermined optical path. The half mirror 184b is disposed on a predetermined optical path and reflects the expanded blue laser light beam 185b along the predetermined optical path. Therefore, beam light 187 obtained by combining the laser light beams 185 is emitted from a predetermined optical path.

The exposure section 190 includes a beam splitter 191, a fixed mirror 192, movable mirrors 193a and 193b, first to third stages 194a to 194c, and an aperture 195. The beam splitter 191 divides the beam light 187, which is incident from the light source section 180 along the predetermined optical path, into beam light for the fixed mirror 192 and the movable mirror 193a, and then emits the divided beam light. The fixed mirror 192 emits the incoming beam light to the movable mirror 193b. The movable mirror 193a is rotatable and reflects the beam light 187 toward one surface of a sample 200. The movable mirror 193b is rotatable and reflects the beam light 187 toward the other surface of the sample 200.

The first to third stages 194a to 194c are movable along a direction parallel to each other (Y direction). The first stage 194a supports the movable mirror 193a, and the second stage 194b supports the movable mirror 193b. Further, the third stage 194c supports the sample 200 and is capable of moving the sample 200 along the Z-axis direction. Here, for the sample 200, one formed by attaching a photosensitive photopolymer to a transparent substrate such as glass is used.

The RGB laser light beams 185 are expanded by the beam expander, and the beam wavefronts thereof are made uniform. The laser light beams 185 of the respective colors are combined by the mirror 183 and the half mirrors 184a and 184b and then emitted as beam light. The beam light 187 is demultiplexed into two beams by using the beam splitter, and the two beams serving as reference light and object light are applied to the surfaces of the sample 200 by using the movable mirrors 193a and 193b. At that time, the angles of the reference light and the object light are deflected, and interference fringes are exposed at a desired exposure angle.

When the third stage 194c moves in the Y direction or the Z direction, the area in which the interference fringes are exposed can be increased. Further, if the mirror angle is changed in accordance with the exposure position, it is possible to perform exposure while changing a slant angle in the hologram surface. In this case, in the reflective hologram, the slant angle of the interference fringes differs depending on the exposure position. For example, this method is used in a case where exposure is performed while changing the slant angle for each elevation angle with respect to the position of the pupil. This makes it possible to control the direction, in which the light is diffracted and reflected, for each position.

For the focal point of an object light lens 210, the object light lens 210 is adjusted so as to obtain a desired distance of the real image and the object image. Similarly, for the focal point of a reference light lens 220, the reference light lens 220 is adjusted so as to obtain a desired distance of the real image and the object image. It is desirable to arrange the optical axes of the object light lens 210 and the reference light lens 220 so as to form an intersection on the photopolymer.

Note that the exposed sample 200 may be used while being attached to the glass or may be, after the photopolymer is peeled off therefrom, attached again to another substrate such as an acrylic plate. Note that the substrate may be not only a flat surface but also a curved surface.

Note that if the exposure apparatus 170 is used in a single color, the exposure may be performed in a single color with the same configuration. Further, if the wavelength at the time of exposure and the wavelength at the time of reproduction are different from each other, the focal point of the object light and the focal point of the reference light may be shifted for exposure, and the wavelength dependency of aberrations due to the difference in exposure and reproduction may be corrected in advance.

At least two of the characteristic portions according to the present technology described above can be combined. In other words, the various characteristic portions described in each embodiment may be discretionarily combined without distinguishing between the embodiments. Further, the various effects described above are not limitative but are merely illustrative, and other effects may be provided.

In the present disclosure, “same”, “equal”, “orthogonal”, and the like are concepts including “substantially the same”, “substantially equal”, “substantially orthogonal”, and the like. For example, the states included in a predetermined range (e.g., range of ±10%) with reference to “completely the same”, “completely equal”, “completely orthogonal”, and the like are also included.

Note that the present technology may also take the following configurations.
(1) A display apparatus, including
   a display unit group including at least two or more sets of display units disposed in a circumferential direction, each set of the display units including
   a screen onto which an object image is projected from a projection apparatus, and
   a reflective holographic lens that diffracts the object image and delivers the object image to a pupil of an observer.
(2) The display apparatus according to (1), in which
   the reflective holographic lens is capable of displaying a video by superimposition on a background, and
   a real image of the reflective holographic lens is located between the pupil of the observer and the reflective holographic lens.
(3) The display apparatus according to (2), in which
   in the display unit group, an optical axis of the reflective holographic lens of each set intersects with the center axis passing through the center of a circle inscribed on a surface of the reflective holographic lens of each set.
(4) The display apparatus according to (3), in which
   a position of the real image is located on the optical axis and is matched with the center axis inscribed on the surface of the reflective holographic lens of each set.
(5) The display apparatus according to (3), in which
   in the display unit group, the center of a circle inscribed on each surface of the screen onto which the object image is projected is matched with the center axis.
(6) The display apparatus according to (1), in which
   the reflective holographic lens is a holographic optical element (HOE), and
   the reflective holographic lens forms an angle with another adjacent reflective holographic lens, the angle being equal to or less than a half width at half maximum of a diffusion angle in an azimuth direction of the screen.
(7) The display apparatus according to (1), in which
   the half width at half maximum of the diffusion angle in the azimuth direction of the screen is set to a half-value angle of diffraction efficiency of the HOE.

### REFERENCE SIGNS LIST

1 projector
3 screen
5 reflective holographic lens
7 real image
10 display unit
100 display unit group
110 display apparatus
130 display apparatus
150 display apparatus

1. A display apparatus, comprising
a display unit group including at least two or more sets of display units disposed in a circumferential direction, each set of the display units including
a screen onto which an object image is projected from a projection apparatus, and
a reflective holographic lens that diffracts the object image and delivers the object image to a pupil of an observer.

2. The display apparatus according to claim 1, wherein
the reflective holographic lens is capable of displaying a video by superimposition on a background, and
a real image of the reflective holographic lens is located between the pupil of the observer and the reflective holographic lens.

3. The display apparatus according to claim 2, wherein
in the display unit group, an optical axis of the reflective holographic lens of each set intersects with the center axis passing through the center of a circle inscribed on a surface of the reflective holographic lens of each set.

4. The display apparatus according to claim 3, wherein
a position of the real image is located on the optical axis and is matched with the center axis inscribed on the surface of the reflective holographic lens of each set.

5. The display apparatus according to claim 3, wherein
in the display unit group, the center of a circle inscribed on each surface of the screen onto which the object image is projected is matched with the center axis.

6. The display apparatus according to claim 1, wherein
the reflective holographic lens is a holographic optical element (HOE), and
the reflective holographic lens forms an angle with another adjacent reflective holographic lens, the angle being equal to or less than a half width at half maximum of a diffusion angle in an azimuth direction of the screen.

7. The display apparatus according to claim 1, wherein
the half width at half maximum of the diffusion angle in the azimuth direction of the screen is set to a half-value angle of diffraction efficiency of the HOE.
